(19) United States
(12) Patent Application Publication
(10) Pub. No.: US 2011/0161237 A1
(43) Pub. Date: Jun. 30, 2011

(54) Information Recording Method and Apparatus for Computer System

(76) Inventor: Fang-Yuan Sung, Taipei Hsien (TW)

(21) Appl. No.: 12/876,254

(22) Filed: Sep. 7, 2010

(30) Foreign Application Priority Data
Dec. 29, 2009 (TW) 098145553

(51) Int. Cl. G06Q 10/00

(52) U.S. Cl. 705/302

(57) ABSTRACT

An information recording method for providing a warranty basis in a computer system, includes obtaining a usage information when the computer system triggers a boot procedure, and recording a system information of the computer system and updating the usage information when the usage information indicates that the boot procedure is the first one boot procedure triggered by the computer system after the computer system is sold.

### BACKGROUND OF THE INVENTION

1. Field of the Invention

The present invention relates to an information recording method and device for a computer system, and more particularly, to an information recording method and device capable of avoiding dispute over warranty identification.

2. Description of the Prior Art

Warranty is a gratuitous return or exchange mechanism against non-personal defects within a specific duration after a product is sold, and is an important means to enhance product competition. In general, for avoiding debate on purchasing time, a retailer usually provides a warranty card recording a purchase date, which provides a basis for identifying the purchasing time. In addition, as to a product carrying a serial number, a consumer or retailer may register the serial number to a specific website, providing another basis for identifying the purchasing time. However, when the warranty card is lost and the consumer and the retailer do not register the serial number, warranty identification would be based on an ex-factory date. As a result, a dispute is aroused between the customer and the manufacturer.

For example, after purchasing a computer system, if a customer encounters frequent crashes caused by a memory defect within a warranty time, the customer can deliver the malfunctioned computer system to a maintenance center of the corresponding manufacturer. The maintenance center determines whether warranty is effective according to a warranty card provided by the customer or data on the website, and decides whether to replace with a new one for free or a certain price. Under such circumstances, if the consumer cannot provide the warranty card (due to lost or not provided by the retailer) or did not register related information to the website, the maintenance center would identify the ex-factory date as a starting date of the warranty time; hence, the warranty may be ineffective, causing the customer dissatisfaction, and the customer may resort to mass media or actions at law, which further impairs enterprise image.

Therefore, how to properly identify the warranty time to avoid dispute between the customer and the manufacturer is important for modern society.

### SUMMARY OF THE INVENTION

It is therefore a primary objective of the claimed invention to provide an information recording method and an information recording device for a computer system.

The present invention discloses an information recording method for providing a warranty basis in a computer system, including obtaining a usage information when the computer system triggers a boot procedure, and recording a system information of the computer system and updating the usage information when the usage information indicates that the boot procedure is the first one boot procedure triggered by the computer system after the computer system is sold.

The present invention further discloses an information recording device for providing a warranty basis in a computer system, including an information obtaining unit, for obtaining a usage information when the computer system triggers a boot procedure, and an execution unit, for recording a system information of the computer system and updating the usage information when the usage information indicates that the boot procedure is the first one boot procedure triggered by the computer system after the computer system is sold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an information recording process according to an embodiment of the present invention.

FIG. 2 is a schematic diagram of operations of the information recording process in FIG. 1.

FIG. 3 is a schematic diagram of an information recording device according to an embodiment of the present invention.

FIG. 4 is a schematic diagram of a motherboard according to an embodiment of the present invention.

### DETAILED DESCRIPTION

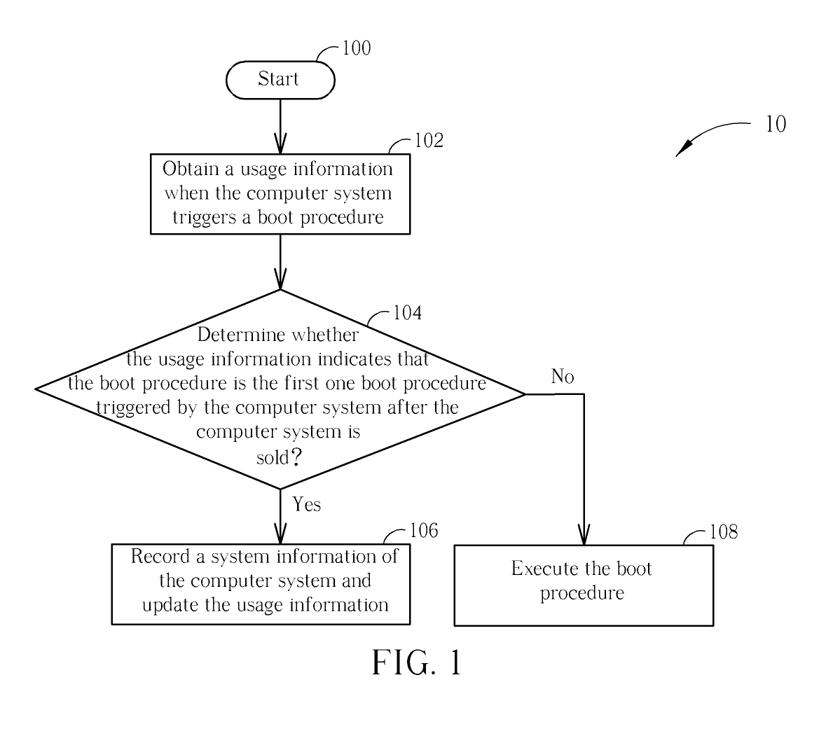

Aiming at a warranty of a computer system, for avoiding differentials in identifying warranty time between a customer and a manufacturer, the present invention timely records specific information of the computer system as a warranty basis. Please refer to FIG. 1. FIG. 1 is a schematic diagram of an information recording process 10 according to an embodiment of the present invention. The information recording process 10 is utilized for providing a warranty basis in a computer system, and includes the following steps:

Step 100: Start.

Step 102: Obtain a usage information when the computer system triggers a boot procedure.

Step 104: Determine whether the usage information indicates that the boot procedure is the first one boot procedure triggered by the computer system after the computer system is sold. If true, execute step 106; else, execute step 108.

Step 106: Record a system information of the computer system and update the usage information.

Step 108: Execute the boot procedure.

According to the information recording process 10, when the computer system is started for the first time after the computer system is sold, the present invention records the system information of the computer system, and whether a boot procedure is the first one after sold is determined based upon the usage information. In detail, before selling the computer system, the manufacturer or the retailer sets the usage information to be “unused”. When the consumer uses the computer system for the first time after buying it, the computer system records the system information according to the usage information, and updates the usage information to be “used”.

Hence, via the information recording process 10, the computer system automatically records the system information when the computer system is started for the first time after the computer system is sold, which provides a basis for identifying the warranty time. Note that, the information recording process 10 is utilized for illustrating the spirit of the present invention, and modifications or variations thereof are within the scope of the invention. For example, the usage information for indicating whether the computer system is firstly used after sold may be digital data stored in a basic input/output system (BIOS), specific memory, or information storing devices of other formats, which can preferably modified to “first use” via specific software or hardware by the manufacturer or the retailer. Moreover, the system information recorded by the computer system may include the first boot time, the serial number, etc, for certificating the first use. Furthermore, after the computer system records the system information, the present invention may further transmit the system information to a specific website when the computer system is connected to Internet, to perform product registration automatically.

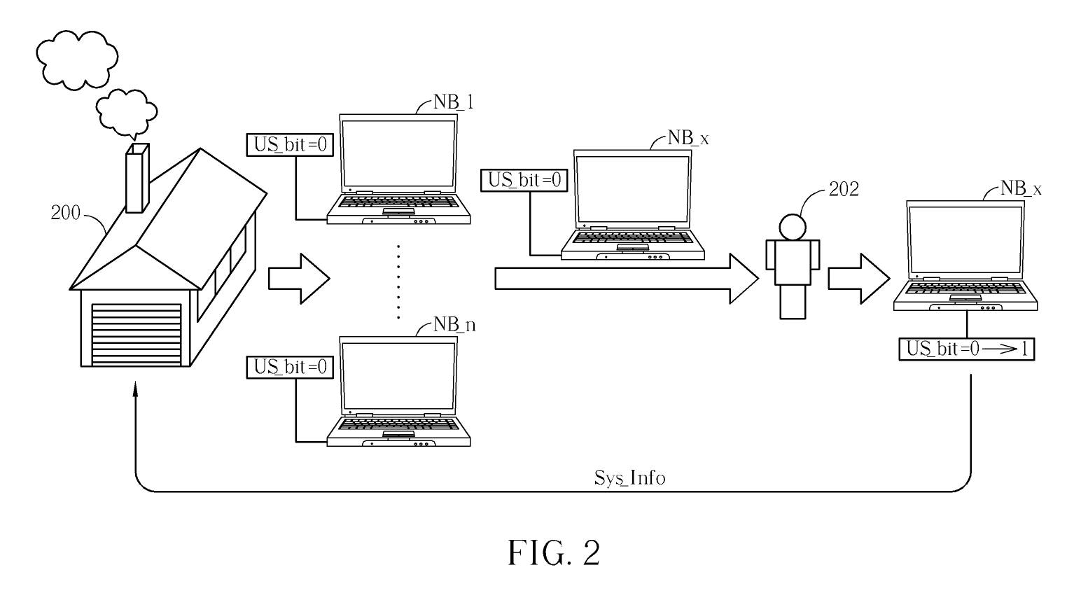

The above operations can be illustrated by an exemplary embodiment shown in FIG. 2. In FIG. 2, a usage information bit US_bit is recorded in each of laptops NB_{—}1-NB_n by a laptop manufacturer 200 according to the concept of the present invention. The usage information bit US_bit can be stored in a storage device such as BIOS, hard disk, or memory, and represents that the corresponding laptop is not yet used when US_bit=0, or on the contrary, represents that the laptop is used when US_bit=1. Suppose a consumer 202 purchases a laptop NB_x of the laptops NB_{—}1-NB_n. When the consumer 202 uses the laptop NB_x for the first time, according to the present invention, the laptop NB_x automatically records a system information Sys info (such as the boot time and the serial number), and updates the usage information bit US_bit to be 1. In the meanwhile, when a user surfs Internet via the laptop NB_x, the laptop NB_x may further send back the system information Sys_info to the predefined website for performing product registration. Therefore, when a non-personal damage occurs in the laptop NB_x, the laptop manufacturer 200 determines whether the laptop NB_x is under warranty according to the system information Sys_info, and dispute over identification of the purchase date is therefore avoided, so as to enhance the enterprise image of the laptop manufacturer 200.

Note that, FIG. 2 takes the laptops for illustrating the spirit of the present invention. In practice, every electronic product including essential elements of a computer system (such as CPU, motherboard, and memory) belongs to the computer system specified herein, such as smart phone, personal computer, home media center, and TV game console, and may adopt the warranty identification mechanism of the present invention with adequate modifications. In addition, the above description focus on the concept of the present invention, and undisclosed techniques can be easily derived or deduced by those skilled in the art. For example, in FIG. 2, when an error occurs in the process that the laptop NB_x ends back the system information Sys_info to the laptop manufacturer 200, the laptop manufacturer 200 may actively contact the consumer 202 to have the laptop NB_x repaired. The error may be an unreasonable boot time caused by a dead battery supplying operations of a system clock in the laptop NB_x.

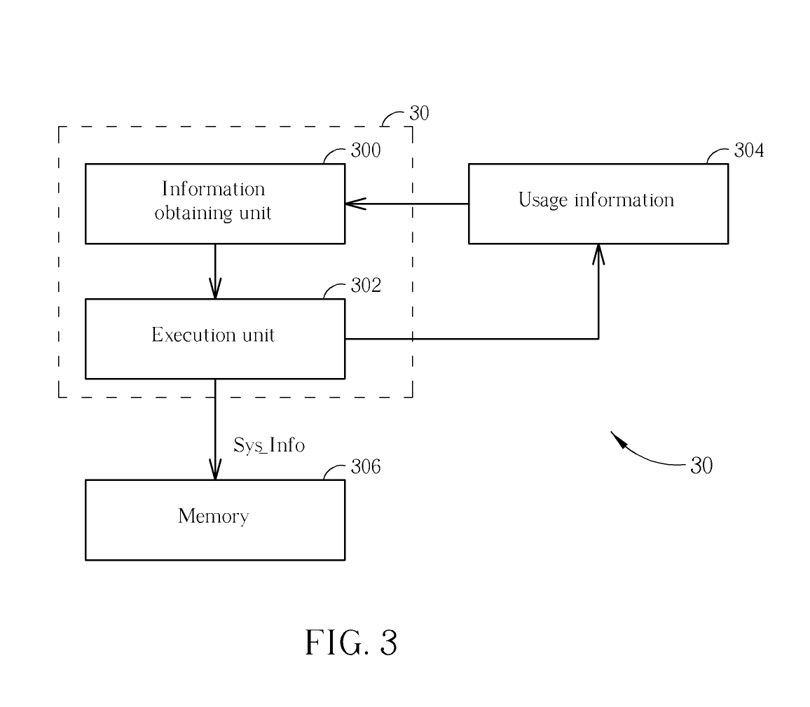

On the other hand, an implementation of the information recording process 10 is not limited to software or hardware as long as the present invention can be accurately implemented in an application field. If a software implementation in a personal computer is taken as an example, the information recording process 10 can be transformed into an application program, which cooperates with BIOS. That is, when the personal computer is started, the BIOS determines whether the personal computer is used for the first time according to the usage information. If true, the BIOS records the related information in a memory of a controller. After the personal computer is started, the controller instructs BIOS to execute the application program according to data stored in the memory, and outputs system time and a serial number to the application program, so as to store or further transmit the system time and the serial number to a specific website. Certainly, the above software implementation is an exemplary embodiment, and such a process of transforming the information recording process 10 into the application program is well-known for those skilled in the art. Specifically, the implementation method of the information recording process 10 can be illustrated by a block diagram as shown in FIG. 3. FIG. 3 is a schematic diagram of an information recording device 30 according to an embodiment of the present invention. The information recording device 30 is utilized for providing a warranty basis in a computer system, and includes an information obtaining unit 300 and an execution unit 302. The information obtaining unit 300 is used for implementing the step 102 to obtain a usage information 304 when the computer system triggers a boot procedure. The execution unit 302 is used for implementing the step 104 to record the system information Sys Info in a memory 306 and update the usage information 304 when the usage information 304 indicates that the current boot procedure is the first one boot procedure triggered by the computer system after the computer system is sold. Operations and variations of the information recording device 30 can be referred to the above and are not narrated herein.

The information recording device 30 shown in FIG. 3 illustrates the implementation method of the present invention, and each unit can be modified according to system requirements. For example, besides digital data, the usage information 304 can also be obtained by certain direct or indirect means. For example, the usage information 304 can be indicated by whether the memory 306 stores any data; that is, when the computer system is started, the information obtaining unit 300 examines whether the memory 306 stores data, and determines that the current boot procedure is the first one boot procedure triggered by the computer system after sold when no data is stored in the memory 306. In addition, the memory 306 can be a specific storage area of a hard disk or a one-time programmable read only memory (OTPROM), which can perform data recording for only one time to avoid falsification of the usage information 304.

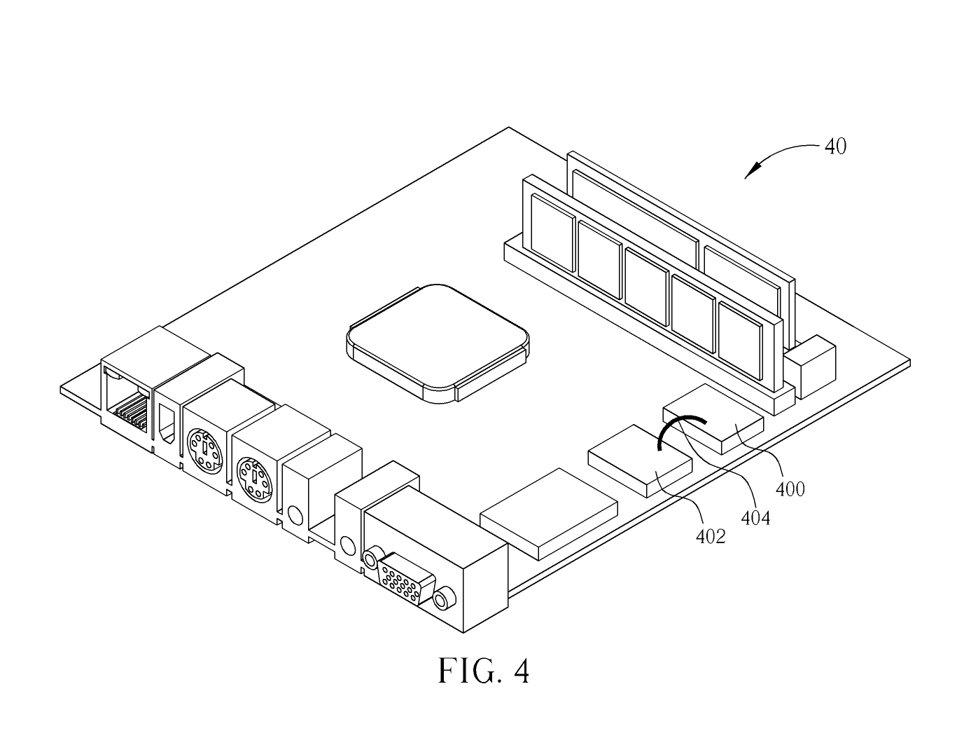

In addition, the usage information 304 can also be generated by a hardware circuit. For example, please refer to FIG. 4, which is a schematic diagram of a motherboard 40. In the motherboard 40, a power transmission unit 400 transmits current to a power reception unit 402 via a fuse 404, and specification of the fuse 404 can be determined according current outputted from the power transmission unit 400, for example, to select a material of the fuse 404 so that the fuse 404 is burned out when the power transmission unit 400 continuously transmits current to the power reception unit 402 for 5 seconds. Accordingly, after the computer system is started, the information obtaining unit 300 determines the usage information 304 based on whether the power reception unit 402 receives the current outputted from the power transmission unit 400. Certainly, generating the usage information 304 by the fuse 404 is also an exemplary embodiment of the present invention.

Note that, the motherboard 40 shown in FIG. 4 is used to illustrate a possible method of generating the usage information 304, rather than posing any limitations on the scope of the present invention. In practice, besides the motherboard 40, the fuse 404 can also be disposed on other external devices, such as battery, for timely generating the usage information 304.

In the prior art, neither the warranty card nor the registration on the website avoids the dispute over the identification of the warranty time. Such appearance usually causes a quarrel between the customer and the manufacturer, and further impairs the enterprise image. In comparison, the present invention provides a mechanism for properly identifying the warranty time, which passively avoids dispute between the customer and the manufacturer and actively enables the manufacturer to contact the customer for maintenance. Accordingly, the enterprise image is further enhanced.

To sum up, the present invention records the time of the computer system starts for the first time after sold as a warranty basis. Accordingly, the dispute over the identification of the warranty can be avoided, so as to maintain the enterprise image.

Those skilled in the art will readily observe that numerous modifications and alterations of the device and method may be made while retaining the teachings of the invention.

What is claimed is:

1. An information recording method for providing a warranty basis in a computer system, comprising:
obtaining a usage information when the computer system triggers a boot procedure; and
recording a system information of the computer system and updating the usage information when the usage information indicates that the boot procedure is the first one boot procedure triggered by the computer system after the computer system is sold.

2. The information recording method of claim 1, wherein the usage information is generated by a manufacturer of the computer system.

3. The information recording method of claim 1, wherein the usage information is a digital data stored in a basic input/output system of the computer system.

4. The information recording method of claim 1, wherein the step of obtaining the usage information when the computer system triggers the boot procedure is determining a status of a fuse to obtain the usage information when the computer system triggers the boot procedure.

5. The information recording method of claim 4, further comprising determining that the usage information indicates that the boot procedure is the first one boot procedure triggered by the computer system after the computer system is sold when the fuse is not yet burned out.

6. The information recording method of claim 5, wherein the step of updating the usage information is burning out the fuse.

7. The information recording method of claim 1, wherein the system information comprises a date of the computer system triggering the boot procedure.

8. The information recording method of claim 1, wherein the system information comprises a serial number of the computer system.

9. The information recording method of claim 1, wherein the step of recording the system information of the computer system is storing the system information of the computer system in a one-time programmable memory.

10. The information recording method of claim 1, further comprising transmitting the system information to a predefined website via Internet when the computer system is connected to Internet.

11. An information recording device for providing a warranty basis in a computer system, comprising:
an information obtaining unit, for obtaining a usage information when the computer system triggers a boot procedure; and
an execution unit, for recording a system information of the computer system and updating the usage information when the usage information indicates that the boot procedure is the first one boot procedure triggered by the computer system after the computer system is sold.

12. The information recording device of claim 11, wherein the usage information is generated by a manufacturer of the computer system.

13. The information recording device of claim 11, wherein the usage information is a digital data stored in a basic input/output system of the computer system.

14. The information recording device of claim 11, further comprising a fuse, for generating the usage information.

15. The information recording device of claim 14, wherein the information obtaining unit determines that the usage information indicates that the boot procedure is the first one boot procedure triggered by the computer system after the computer system is sold when the fuse is not yet burned out.

16. The information recording device of claim 15, wherein the execution unit burns out the fuse to update the usage information.

17. The information recording device of claim 11, wherein the system information comprises a date of the computer system triggers the boot procedure.

18. The information recording device of claim 11, wherein the system information comprises a serial number of the computer system.

19. The information recording device of claim 11, further comprising a one-time programmable memory, and the execution unit stores the system information of the computer system into the one-time programmable memory.

20. The information recording device of claim 11, wherein the execution unit is further utilized for transmitting the system information to a predefined website via Internet when the computer system is connected to Internet.
